(19) United States
(12) Patent Application Publication
(10) Pub. No.: US 2019/0255682 A1
(43) Pub. Date: Aug. 22, 2019

(54) TOOL WITH TEETH ON SIDE

(71) Applicant: Snap-on Incorporated, Kenosha, WI (US)

(72) Inventors: Douglas A. Moyer, Racine, WI (US); Arendt M. Jeffrey, Union Grove, WI (US)

(73) Assignee: Snap-on Incorporated, Kenosha, WI (US)

(21) Appl. No.: 15/901,048

(22) Filed: Feb. 21, 2018

(51) Int. Cl. B25B 7/10

(52) U.S. Cl. CPC B25B 7/10

(57) ABSTRACT

Disclosed is a tool, such as pliers, having a reduced spacing between adjustment teeth, and an elongated slot; thereby providing an improved adjustability and larger capacity to hold workpieces. In particular, the spacing of the adjustment teeth and length of the slot provide more adjustment positions and allow more teeth to be engaged at all positions. For example, the teeth may be spaced at 0.098 inches and the tool may provide a maximum jaw opening of 2.24 inches.

### TECHNICAL FIELD OF THE INVENTION

The present invention relates generally to tools, such as pliers. More particularly, the present invention relates to a tool with teeth on a side of a handle portion.

### BACKGROUND OF THE INVENTION

Hand tools have been around for years in many forms. To increase the usefulness of some hand tools, features were developed to allow the tools to adjust to varying workpiece sizes. That is, instead of changing to a bigger or smaller tool, a single tool could be adjusted to accommodate a larger or smaller sized workpiece, saving on time and the number of tools required for any given job.

One example of such a tool is disclosed in U.S. Patent Application Publication 2010/0018364 to Chervenak et al. This application discloses pliers that include first and second adjustment members, each with a handle portion and a jaw portion. The first member defines an aperture for receiving the second member, and the second member includes an elongated slot and a row of teeth that allows adjustment of the pliers.

However, current tools are limited in their capability to adjust and hold varying types of workpieces.

### SUMMARY OF THE INVENTION

The present invention broadly comprises a tool, such as pliers, having a reduced spacing between adjustment teeth, and an elongated slot; thereby providing an improved adjustability and larger capacity to hold workpieces. In particular, the spacing of the adjustment teeth and length of the slot provide more adjustment positions and allow more teeth to be engaged at all positions. For example, the teeth may be spaced at 0.098 inches and the tool may provide a maximum jaw opening of 2.24 inches.

In an embodiment, the present invention includes a tool including a first portion having a first jaw portion and a first handle portion, and a second portion having a second jaw portion and a second handle portion. A first slot is disposed in the first portion between the first jaw portion and the first handle portion, and the second portion is disposed in the first slot with the second jaw portion proximal to the first jaw portion. An elongated slot is disposed in the second portion between the second jaw portion and the second handle portion, and teeth are disposed on the second portion proximal to the elongated slot. The teeth are spaced with respect to one another at about 0.098 inches. This allows an opening between the first and second jaw portions to be adjusted in 0.098 inch increments.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a side perspective view of a tool according to an embodiment of the present invention.

FIG. 2 is an exploded view of the tool of FIG. 1.

FIG. 3 is a first side view of the tool of FIG. 1.

FIG. 4 is a second side view of the tool of FIG. 1.

FIG. 5 is a top side view of the tool of FIG. 1.

FIG. 6 is a bottom side view of the tool of FIG. 1.

### DETAILED DESCRIPTION OF THE EMBODIMENTS

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

The present invention broadly comprises a tool, such as pliers, having a reduced spacing between adjustment teeth, and an elongated slot; thereby providing an improved adjustability and larger capacity to hold workpieces. In particular, the spacing of the adjustment teeth and length of the slot provide more adjustment positions and allow more teeth to be engaged at all positions. For example, the teeth may be spaced at 0.098 inches and the tool may provide a maximum jaw opening of 2.24 inches.

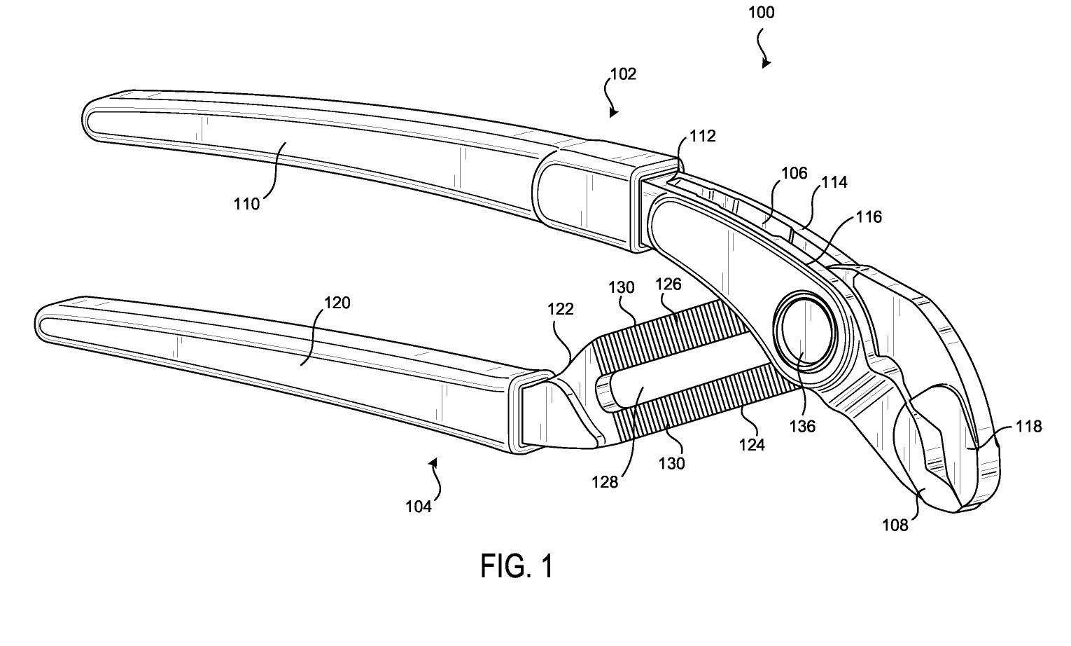

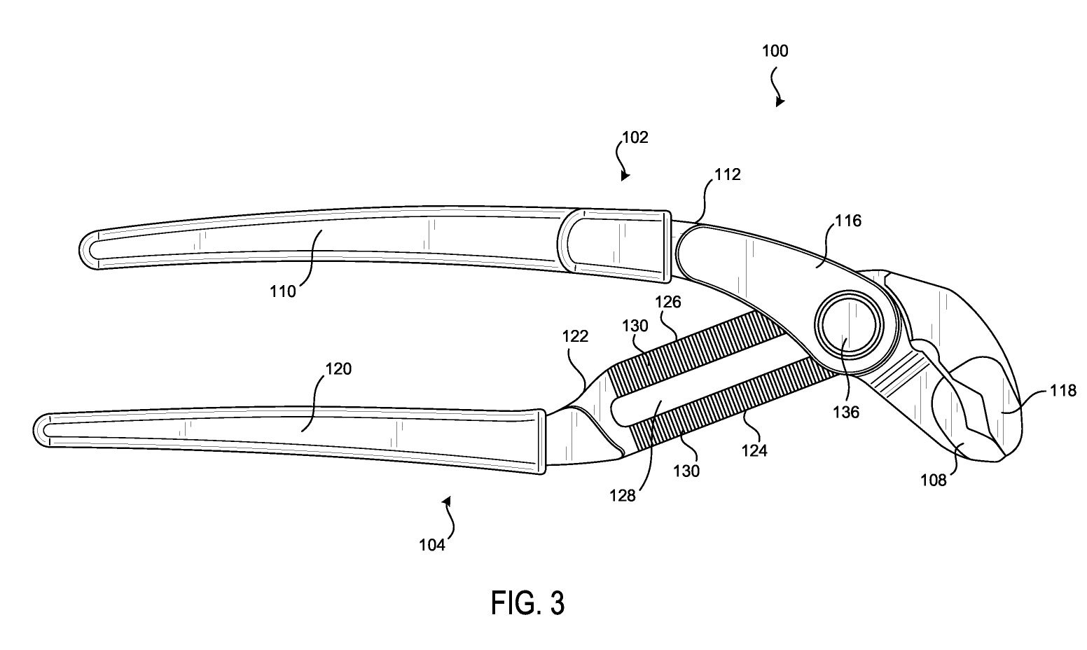

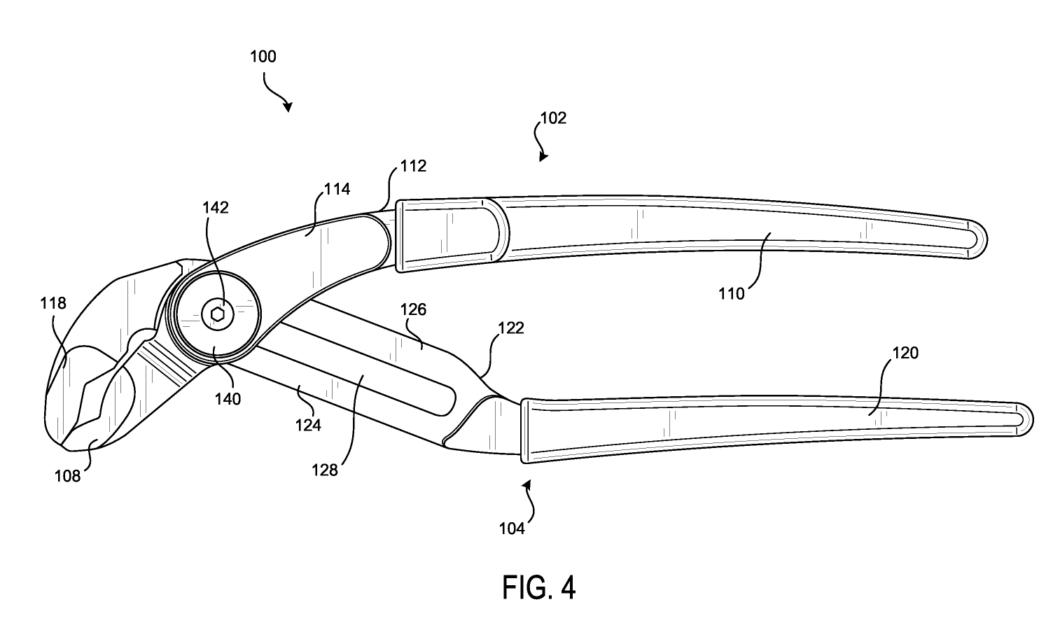

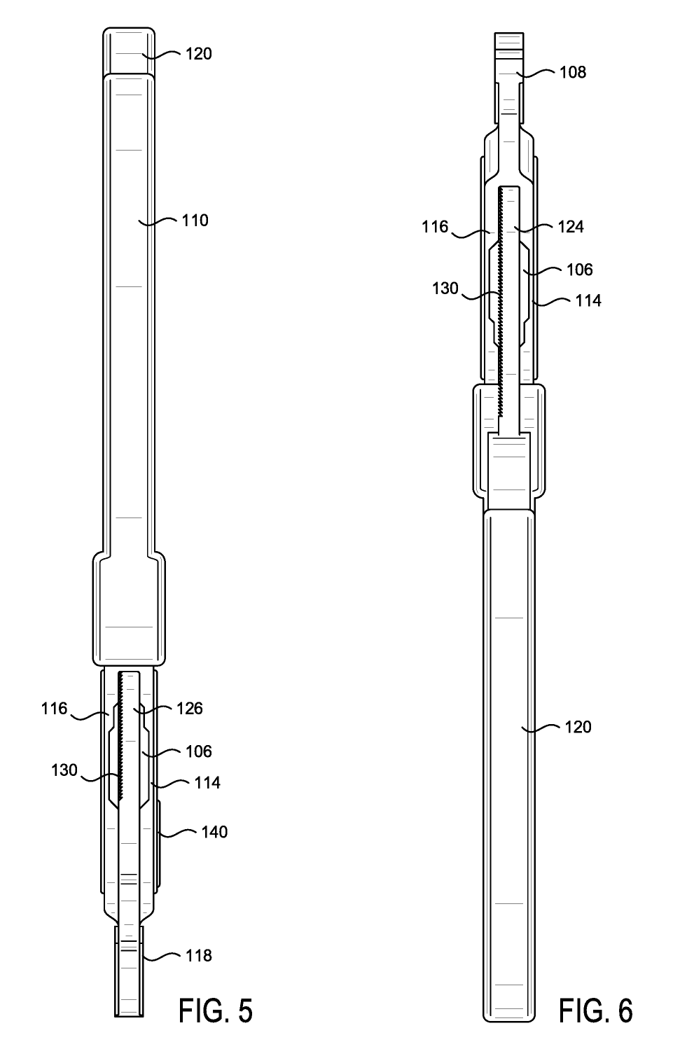

Referring to FIGS. 1-6, a tool 100, such as pliers, includes a first portion 102 and a second portion 104. The first portion 102 includes a slot 106 adapted to receive the second portion 104. The first portion 102 also includes a first jaw portion 108 at a first end of the first portion 102, a first handle portion 110 at a second end of the first portion 102 opposite the first jaw portion 108, and a first adjustment portion 112 between the first jaw portion 108 and first handle portion 110. The first adjustment portion 112 includes first and second opposing side portions 114, 116 that form the slot 106 there between.

The second portion 104 includes a second jaw portion 118 at a first end of the second portion 104, a second handle portion 120 at a second end of the second portion 104 opposite the second jaw portion 118, and a second adjustment portion 122 between the second jaw portion 118 and second handle portion 120. The second adjustment portion 122 includes first and second side portions 124, 126 that form an elongated slot 128 there between. As illustrated in FIG. 1, each of the first and second side portions 124, 126 includes teeth 130 on one side of the respective first and second side portions 124, 126. In an embodiment, the teeth 130 are spaced at 0.098 inches from one another and the elongated slot 128 is sized to provide a maximum jaw opening (i.e., distance between the first and second jaw portions 108, 118) of 2.24 inches. The second portion 104 is disposed in the slot 106 of the first portion 102, and the elongated slot 128 is aligned with an aperture 132 in the first adjustment portion 112 of the first portion 102. An adjustment member 134 couples the first and second portions 102, 104 together, allowing the first and second portions 102, 104 to pivot with respect to each other to open and close the first and second jaw portions.

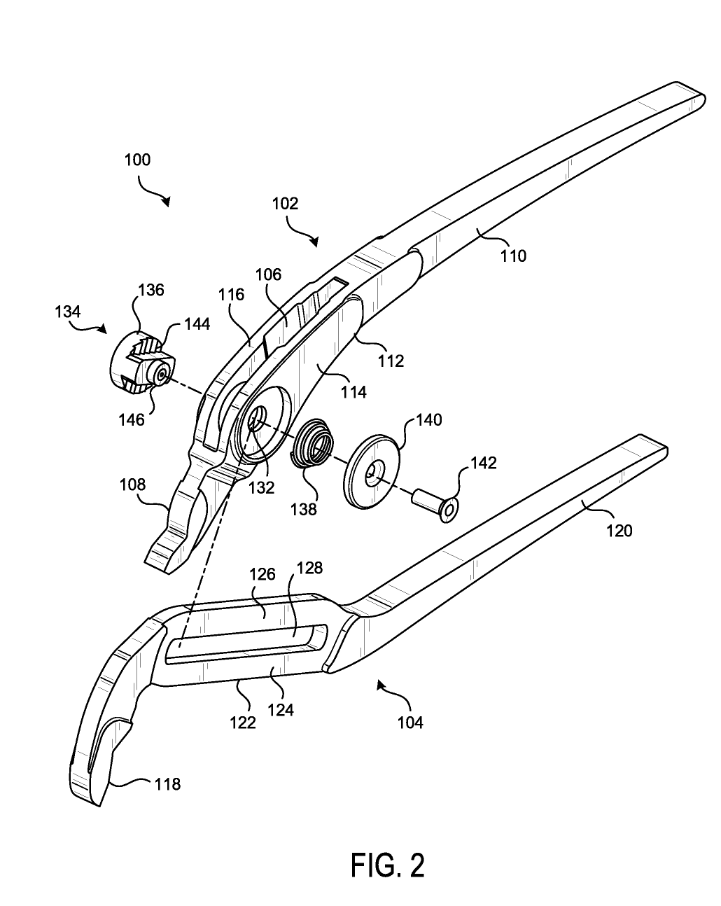

Referring to FIG. 2, the tool 100 also includes an adjustment member 134. The adjustment member includes a pawl 136, a bias member 138, a button 140, and a fastener 142. The pawl 136 includes teeth 144 adapted to mate with and engage teeth 130 on the first and second side portions 124, 126, and a fastener receiving portion 146 adapted to mate with the fastener 142. The pawl 136 is disposed in the aperture 132 adjacent an external surface of the second side portion 116. The pawl 136 may be keyed to the aperture to prevent rotation of the pawl 136 with respect to the first portion 102. The bias member 138 (which may be a spring) is disposed in a recess disposed in the first side portion 114. The button 140 is disposed adjacent the bias member 138 in the recess. The fastener 142 extends through the button 140 and bias member 138, and is coupled to the fastener receiving portion 146 of the pawl 136. The bias member 138 biases the button 140 and fastener 142 outwardly away from the first side portion 114, thereby causing the teeth 144 of pawl 136 to engage the teeth 130. When the button 140 is depressed against the bias force of the bias member 138, the teeth 144 of pawl 136 disengage the teeth 130.

In operation, a user may adjust the size of the opening between the first and second jaw portions 108, 118 by moving or sliding the first portion 102 with respect to the second portion 104 along elongated slot 128, or vice versa. This moves a pivot point between the first and second portions 102, 104 and defined by the adjustment member 134. For example, to make a size of the opening smaller, the first portion 102 may be moved or slid to an end of the slot 128 proximal to the second jaw portion 118. When the size of the opening is made smaller, the teeth 144 of pawl 136 may ratchet with respect to the teeth 130, thereby allowing the size of the opening to be made smaller without having to depress the button. To make a size of the opening larger, the button may be depressed, thereby disengaging teeth 144 of pawl 136 from teeth 130. While the button is depressed, the first portion 102 may be moved or slid towards an end of the slot 128 distal to the second jaw portion 118.

The spacing of the teeth 144 may be about 0.098 inches or smaller, and the tool may provide a maximum jaw opening of about 2.24 inches. This provides more adjustment positions and allows more teeth 144 to be engaged with teeth 130 at all positions. For example, the size of the opening between the first and second jaw portions 108, 118 may be adjusted in 0.098 inch increments by moving or sliding the first portion 102 with respect to the second portion 104 along elongated slot 128.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A tool comprising:
a first portion having a first jaw portion and a first handle portion;
a first slot disposed in the first portion between the first jaw portion and the first handle portion;
a second portion having a second jaw portion and a second handle portion, the second portion is disposed in the first slot with the second jaw portion proximal to the first jaw portion;
an elongated slot disposed in the second portion between the second jaw portion and the second handle portion;
teeth disposed on the second portion proximal to the elongated slot; wherein the teeth are spaced with respect to one another at about 0.098 inches.

2. The tool of claim 1, wherein a maximum opening between the first and second jaw portions is about 2.24 inches.

3. The tool of claim 1, further comprising a pawl having pawl teeth, wherein the pawl is disposed adjacent a first side of the first portion and extends into an aperture in the first portion, and the pawl teeth are adapted to engage the teeth disposed on the second portion.

4. The tool of claim 3, further comprising a button disposed adjacent a second side of the first portion.

5. The tool of claim 4, further comprising a bias member disposed between the button and the second side of the first portion, wherein the bias member is adapted to bias the button outwardly away from the second side, and the pawl teeth into engagement with the teeth disposed on the second portion.

6. The tool of claim 5, wherein depression of the button against a bias force of the bias member disengages the pawl teeth from the teeth disposed on the second portion.

7. The tool of claim 1, wherein the elongated slot is formed by first and second side portions extending between the second handle portion and the second jaw portion.
